(19) United States
(12) Patent Application Publication
(10) Pub. No.: US 2017/0366875 A1
(43) Pub. Date: Dec. 21, 2017

(54) METHOD AND APPARATUS FOR AUTOMATION OF PERSONALIZED MAINTENANCE TASKS WITH BUILT-IN SIMULATION AND DATA SYNCHRONIZATION SUPPORT IN ENERGY DISTRIBUTION INDUSTRY OR OTHER INDUSTRY

(71) Applicant: Honeywell International Inc., Morris Plains, NJ (US)

(72) Inventors: Soundari Arunachalam, Bangalore (IN); Ramesh Jalgama, Hyderabad (IN); Chandrasekar Reddy Mudireddy, Hyderabad (IN); Shanmugapriya Kanagasabapathy, Bangalore (IN); Sabyasachi Bhattacharyya, Pune (IN)

(21) Appl. No.: 15/616,628

(22) Filed: Jun. 7, 2017

Related U.S. Application Data
(60) Provisional application No. 62/350,400, filed on Jun. 15, 2016.

(51) Int. Cl. H04Q 9/00; G06F 17/50; G06F 3/0482; H04W 4/00; H04B 1/3827

(52) U.S. Cl. CPC H04Q 9/00; H04W 4/008; H04B 1/3833; G06F 3/0482; G06F 17/5009; H04Q 2209/60

(57) ABSTRACT

A method and apparatus perform automation of personalized maintenance tasks with built-in simulation and data synchronization support in the energy distribution industry or other industry. A mobile device includes a transceiver and at least one processing device. The transceiver is configured to communicate with a field device. The at least one processing device is configured to detect a presence of the field device. The at least one processing device is also configured to execute multiple maintenance tasks associated with the field device in response to detecting the presence of the field device. The at least one processing device is also configured to generate a dashboard and present the dashboard on the mobile device. The dashboard displays results of the maintenance tasks to a user.

### CROSS-REFERENCE TO RELATED APPLICATION AND PRIORITY CLAIM

This application claims priority under 35 U.S.C. §119(e) to U.S. Provisional Patent Application No. 62/350,400 filed on Jun. 15, 2016, which is hereby incorporated by reference in its entirety.

### TECHNICAL FIELD

This disclosure relates generally to the automation of tasks such as meter data collection and instrument maintenance using mobile devices. More specifically, this disclosure relates to a method and apparatus for automation of personalized maintenance tasks with built-in simulation and data synchronization support in the energy distribution industry or other industry.

### BACKGROUND

Energy distribution utilities (such as electric, gas, or water companies) often have multiple metering devices distributed over a large area. The manual execution of routine maintenance activities for metering devices is typically time-consuming and error-prone. For example, a technician could spend thirty to forty minutes performing routine maintenance activities for each metering device. As a result, a large number of technicians may be needed, particularly for utility companies that have a large number of metering devices (such as 30,000 or more devices). Also, any manual error with respect to non-performance of a maintenance task could require an additional truck roll to a site, which increases operational expenses of the utility. Moreover, the cycle time to synchronize data gathered during routine maintenance activities with a central utility server is typically at least one day. During that time, the data could be misplaced or lost before synchronization, which would require additional truck rolls. Finally, the training of energy meter maintenance technicians can often be costly.

### SUMMARY

This disclosure provides a method and apparatus for automation of personalized maintenance tasks with built-in simulation and data synchronization support in the energy distribution industry or other industry.

An embodiment of this disclosure provides a method that includes detecting a field device in proximity to a mobile device. The method also includes executing multiple maintenance tasks associated with the field device in response to detecting the field device. The method also includes generating a dashboard and presenting the dashboard on the mobile device. The dashboard displays results of the maintenance tasks to a user.

Another embodiment of this disclosure provides a mobile device that includes a transceiver and at least one processing device. The transceiver is configured to communicate with a field device. The at least one processing device is configured to detect a presence of the field device. The at least one processing device is also configured to execute multiple maintenance tasks associated with the field device in response to detecting the presence of the field device. The at least one processing device is also configured to generate a dashboard and present the dashboard on the mobile device. The dashboard displays results of the maintenance tasks to a user.

Yet another embodiment provides a non-transitory computer readable medium containing instructions that, when executed by at least one processing device, cause the at least one processing device to detect a presence of the field device. The instructions further cause the at least one processing device to execute multiple maintenance tasks associated with the field device in response to detecting the presence of the field device. The instructions further cause the at least one processing device to generate a dashboard and present the dashboard on the mobile device. The dashboard displays results of the maintenance tasks to a user.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates an example system supporting automation of personalized maintenance tasks with built-in simulation and data synchronization support according to this disclosure;

FIG. 3 illustrates an example mobile device supporting automation of personalized maintenance tasks with built-in simulation and data synchronization support according to this disclosure;

FIGS. 4A-4D illustrate a dashboard with types of information according to this disclosure;

FIGS. 5A-5D illustrate a dashboard with additional data according to this disclosure;

FIG. 6 illustrates an example method supporting automation of personalized maintenance tasks according to this disclosure; and

FIG. 7 illustrates an example method supporting simulation of personalized maintenance tasks according to this disclosure.

### DETAILED DESCRIPTION

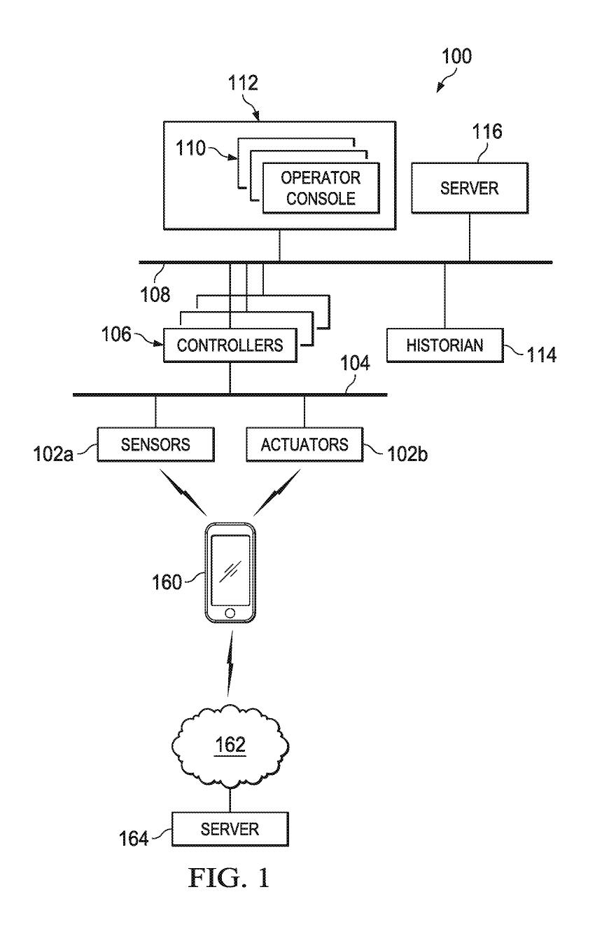

FIGS. 1 through 7, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 can be used to facilitate control over components in one or multiple industrial plants. Each plant represents one or more processing facilities (or one or more portions thereof), such as one or more manufacturing facilities for producing at least one product or other material. In general, each plant may implement one or more industrial processes and can individually or collectively be referred to as a process system. A process system generally represents any system or portion thereof configured to process one or more products or other materials in some manner.

In FIG. 1, the system 100 includes one or more sensors 102a and one or more actuators 102b. The sensors 102a and actuators 102b represent components in a process system that may perform any of a wide variety of functions. For example, the sensors 102a could measure a wide variety of characteristics in the process system, such as pressure, temperature, or flow rate. Also, the actuators 102b could alter a wide variety of characteristics in the process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent at least one Ethernet network, electrical signal network (such as a HART or FOUNDATION FIELDBUS network), pneumatic control signal network, or any other or additional type(s) of network(s). In another example, the network 104 may only provide power to the field devices 102 or the network 104 may not exist.

The system 100 also includes various controllers 106. The controllers 106 can be used in the system 100 to perform various functions in order to control one or more industrial processes. For example, a first set of controllers 106 may use measurements from one or more sensors 102a to control the operation of one or more actuators 102b. A second set of controllers 106 could be used to optimize the control logic or other operations performed by the first set of controllers. A third set of controllers 106 could be used to perform additional functions. The controllers 106 can communicate via one or more networks 108 and associated switches, firewalls, and other components.

Each controller 106 includes any suitable structure for controlling one or more aspects of an industrial process. At least some of the controllers 106 could, for example, represent proportional-integral-derivative (PID) controllers or multivariable controllers, such as controllers implementing model predictive control or other advanced predictive control. As a particular example, each controller 106 could represent a computing device running a real-time operating system, a WINDOWS operating system, or other operating system.

Operator access to and interaction with the controllers 106 and other components of the system 100 can occur via various operator consoles 110. Each operator console 110 could be used to provide information to an operator and receive information from an operator. For example, each operator console 110 could provide information identifying a current state of an industrial process to the operator, such as values of various process variables and alarms associated with the industrial process. Each operator console 110 could also receive information affecting how the industrial process is controlled, such as by receiving setpoints or control modes for process variables controlled by the controllers 106 or other information that alters or affects how the controllers 106 control the industrial process. Each operator console 110 includes any suitable structure for displaying information to and interacting with an operator. For example, each operator console 110 could represent a computing device running a WINDOWS operating system or other operating system.

Multiple operator consoles 110 can be grouped together and used in one or more control rooms 112. Each control room 112 could include any number of operator consoles 110 in any suitable arrangement. In some embodiments, multiple control rooms 112 can be used to control an industrial plant, such as when each control room 112 contains operator consoles 110 used to manage a discrete part of the industrial plant.

The control and automation system 100 here also includes at least one historian 114 and one or more servers 116. The historian 114 represents a component that stores various information about the system 100. The historian 114 could, for instance, store information that is generated by the various controllers 106 during the control of one or more industrial processes, such as actual alarms. The historian 114 includes any suitable structure for storing and facilitating retrieval of information. Although shown as a single component here, the historian 114 could be located elsewhere in the system 100, or multiple historians could be distributed in different locations in the system 100. Each server 116 denotes a computing device that executes applications for users of the operator consoles 110 or other applications. The applications could be used to support various functions for the operator consoles 110, the controllers 106, or other components of the system 100. Each server 116 could represent a computing device running a WINDOWS operating system or other operating system.

One or more embodiments of this disclosure recognize and take into account that there can be various problems or disadvantages associated with technicians' interactions with metering devices or other field devices 102. These can include time-consuming and error-prone manual execution of routine maintenance activities, slow synchronization with data collection servers, and costly training.

Each of multiple users (such as field technicians) uses or has access to a mobile device 160. Each mobile device 160 denotes a portable device that can interact with both a user and one or more field devices 102. In some embodiments, the mobile devices 160 denote smartphones (such as APPLE IPHONE or ANDROID devices), tablet computers (such as APPLE IPAD or ANDROID devices), toughbook, laptop, or other portable electronic device. However, any other suitable mobile devices could be used in the system 100.

The mobile device 160 communicates via at least one wireless network 162 to a server 164. The wireless network 162 could denote any suitable network or combination of networks that can transport data (possibly including voice data) to and from the mobile devices 160. For example, the wireless network 162 could include a cellular network or a local Wi-Fi network.

Although FIG. 1 illustrates one example of an industrial process control and automation system 100, various changes may be made to FIG. 1. For example, the system 100 could include any number of sensors, actuators, controllers, operator stations, networks, and other components. Also, the makeup and arrangement of the system 100 in FIG. 1 are for illustration only. Components could be added, omitted, combined, or placed in any other suitable configuration according to particular needs. Further, particular functions have been described as being performed by particular components of the system 100. This is for illustration only. In general, control and automation systems are highly configurable and can be configured in any suitable manner according to particular needs.

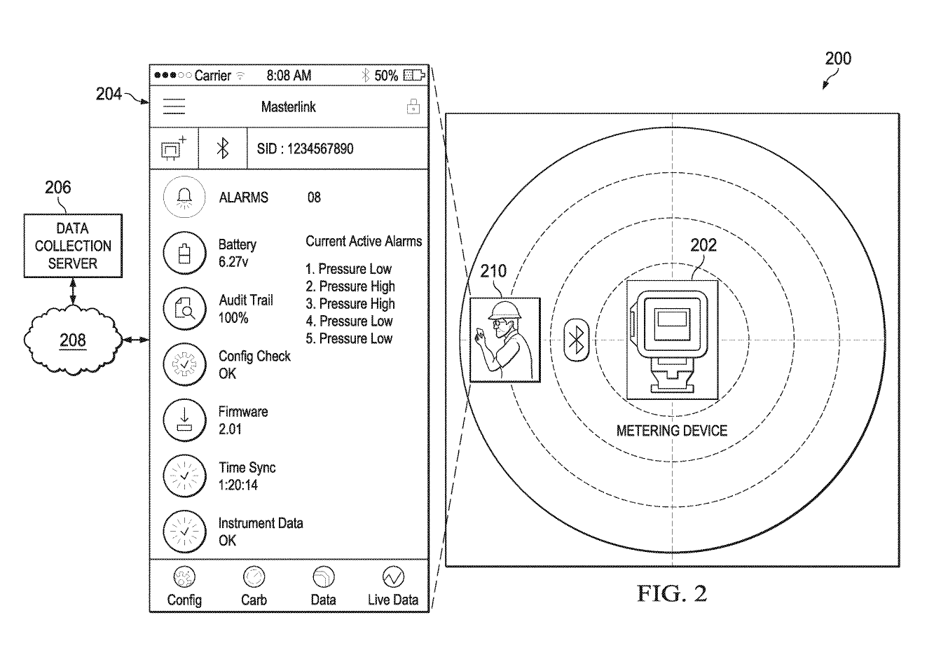

FIG. 2 illustrates an example system 200 supporting automation of personalized maintenance tasks with built-in simulation and data synchronization support according to this disclosure. As shown in FIG. 2, the system 200 includes or is used in conjunction with one or more field devices 202. The field devices 202 denote any suitable equipment with which a technician 210 or other user desires to interact and possibly configure, diagnose, or repair.

In some embodiments, the field devices 202 denote metering devices associated with an electric, gas, water, or other utility company. The system 200 could include any number of field devices 202 distributed in any suitable geographic area(s). In one embodiment, the system 200 could be part of the system 100 in FIG. 1. In other embodiments, the system 200 could be separate from the system 100 or unrelated to the system 100. For example, the mobile device 204 could denote the mobile device 160, the data collection server 206 could denote the server 164, the wireless network 208 could denote the wireless network 162, and the field device 202 could denote one of the field devices 102 shown in FIG. 1 and described above.

In accordance with this disclosure, each mobile device 204 can include a mobile application or “app” that automates routine maintenance tasks performed by a technician 210 or user when the user enters the vicinity of a metering device or other field device 202 (possibly without any user action). For example, automatic connection and execution of tasks could be triggered by “location-based services,” such as by using an APPLE IBEACON located on or near a field device 202 or by using Bluetooth Low Energy (BLE) pairing or other pairing of a mobile device 204 to a field device 202. Data transfers involving a field device 202 and a user's mobile device 204 could occur wirelessly, such as through a wireless BLE interface. Collected data could be automatically sent to and synchronized with a central server 206 or other destination, such as a computing cloud.

At least one data collection server 206 is accessible to the mobile device 204 via the wireless network(s) 208 Each server 206 can collect data from or provide data to the mobile device 204. The data is related to the field devices 202. For example, each server 206 could collect meter readings or other information collected from the field devices 202 using the mobile device 204. Each server 206 could also provide data to the mobile device 204 for use in automating one or more tasks associated with the field devices 202. The server 206 could be referred to as a remote device or system, and include storage.

This approach allows the personalization of maintenance tasks, such as per the needs of a specific industry or a specific user. The results of the tasks performed can be reported in a consolidated manner, such as in the form of a dashboard that allows drill-down for detailed information. This approach could also optimally prevent re-execution of tasks if a technician 210 enters a specified area again by carefully managing registration activities. In addition, the mobile app could be used to provide one or more predefined simulations, which could simulate the behavior of an automated operation and enable a user to gain hands-on experience with the workings of the mobile app. This can help to reduce the learning time associated with the mobile app.

Depending on the implementation, this approach could provide various benefits. Example benefits could include the commencement of maintenance activities when a technician 210 enters a vicinity of a field device 202, which can help to simplify and speed up completion of the activities. Moreover, fully automated and secured field device data backup can occur to a server, centralized cloud, or other location. Further, this approach can allow for continuous or near-continuous data transfers, such as on a low energy interface. In addition, this approach is adaptable as per the latest status of activities and can reduce or eliminate redundant work (e.g., the mobile app could act as an organizer for the technician's routine maintenance tasks and execute independently).

In this way, end users like technicians 210 could see a significant reduction of device maintenance efforts per field device 202. Moreover, the mobile app can provide an improved user experience while the user is performing routine maintenance tasks (which are themselves configurable). Further, the mobile app can help to reduce operating expenses of a utility by eliminating unnecessary truck rolls, increase the coverage in the number of devices managed per technician, and drastically reduce learning time for technicians.

Although FIG. 2 illustrates one example of a system 200 supporting automation of personalized maintenance tasks with built-in simulation and data synchronization support, various changes may be made to FIG. 2. For example, the system 200 could include any number of field devices, mobile devices, wireless networks, and servers. Also, FIG. 2 does not limit this disclosure to any particular configuration or operational environment. In general, the techniques described in this patent document can be used in any suitable system.

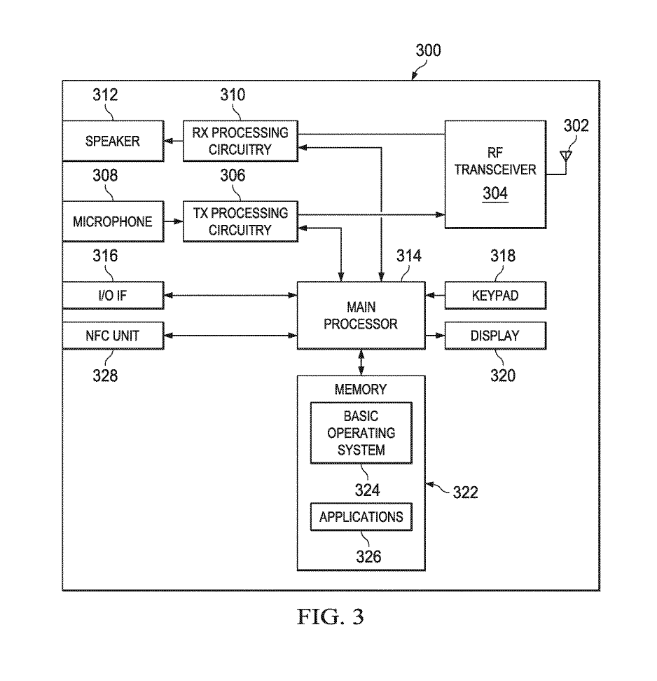

FIG. 3 illustrates an example mobile device 300 supporting automation of personalized maintenance tasks with built-in simulation and data synchronization support according to this disclosure. For example, the mobile device 300 could denote the mobile device 204 shown in FIG. 2 and described above.

As shown in FIG. 3, the mobile device 300 includes an antenna 302, a radio frequency (RF) transceiver 304, transmit (TX) processing circuitry 306, a microphone 308, and receive (RX) processing circuitry 310. The mobile device 300 also includes a speaker 312, a main processor 314, an input/output (I/O) interface (IF) 316, a keypad 318, a display 320, and a memory 322. The memory 322 includes a basic operating system (OS) program 324 and one or more applications 326. In addition, the mobile device 300 includes an NFC unit 328.

The RF transceiver 304 receives, from the antenna 302, an incoming RF signal, such as a cellular or WiFi signal. The RF transceiver 304 down-converts the incoming RF signal to generate an intermediate frequency (IF) or baseband signal. The IF or baseband signal is sent to the RX processing circuitry 310, which generates a processed baseband signal by filtering, decoding, and/or digitizing the baseband or IF signal. The RX processing circuitry 310 transmits the processed baseband signal to the speaker 312 (such as for voice data) or to the main processor 314 for further processing (such as for chat data).

The TX processing circuitry 306 receives analog or digital voice data from the microphone 308 or other outgoing baseband data (such as chat data) from the main processor 314. The TX processing circuitry 306 encodes, multiplexes, and/or digitizes the outgoing baseband data to generate a processed baseband or IF signal. The RF transceiver 304 receives the outgoing processed baseband or IF signal from the TX processing circuitry 306 and up-converts the baseband or IF signal to an RF signal that is transmitted via the antenna 302.

The main processor 314 can include one or more processors or other processing devices and execute the basic OS program 324 stored in the memory 322 in order to control the overall operation of the mobile device 300. For example, the main processor 314 could control the reception of forward channel signals and the transmission of reverse channel signals by the RF transceiver 304, the RX processing circuitry 310, and the TX processing circuitry 306 in accordance with well-known principles. In some embodiments, the main processor 314 includes at least one microprocessor or microcontroller.

The main processor 314 is also capable of executing other processes and applications 326 resident in the memory 322. The main processor 314 can move data into or out of the memory 322 as required by an executing application 326. The main processor 314 is also coupled to the I/O interface 316, which provides the mobile device 300 with the ability to connect to other devices such as laptop computers and handheld computers. The I/O interface 316 is the communication path between these accessories and the main processor 314.

The main processor 314 is also coupled to the keypad 318 and the display 320. The operator of the mobile device 300 can use the keypad 318 to enter data into the mobile device 300. The display 320 may be a liquid crystal display or other display capable of rendering text and/or at least limited graphics, such as from web sites. Note that if the display 320 denotes a touch screen capable of receiving input, fewer or no buttons or keypads may be needed.

The memory 322 is coupled to the main processor 314. Part of the memory 322 could include a random access memory (RAM), and another part of the memory 322 could include a Flash memory or other read-only memory (ROM).

The NFC unit 328 facilitates interactions between the mobile device 300 and other nearby devices, such as the field devices 202. The NFC unit 328 supports any suitable near-field communication technique or other short-range communication technique. In one example, the NFC unit 328 can be referred to as a beacon. In some embodiments, the NFC unit 328 supports BLE. The NFC unit 328 or BLE can be a low-power communication interface.

Although FIG. 3 illustrates one example of a mobile device 300 supporting automation of personalized maintenance tasks with built-in simulation and data synchronization support, various changes may be made to FIG. 3. For example, various components in FIG. 3 could be combined, further subdivided, or omitted and additional components could be added according to particular needs. As a particular example, the processor 314 could be divided into multiple processors, such as one or more central processing units (CPUs) and one or more graphics processing units (GPUs). Also, mobile devices come in a wide variety of configurations, and FIG. 3 does not limit this disclosure to any particular mobile device.

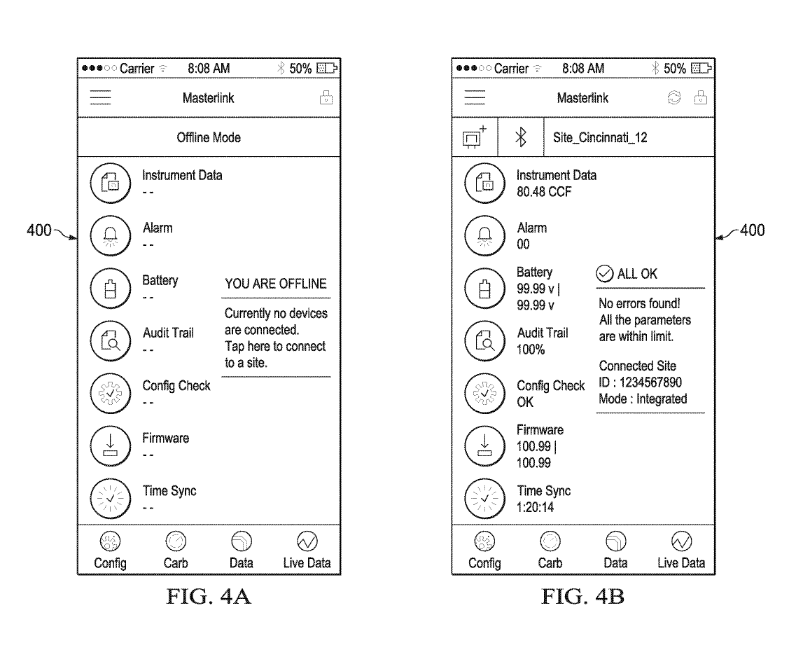

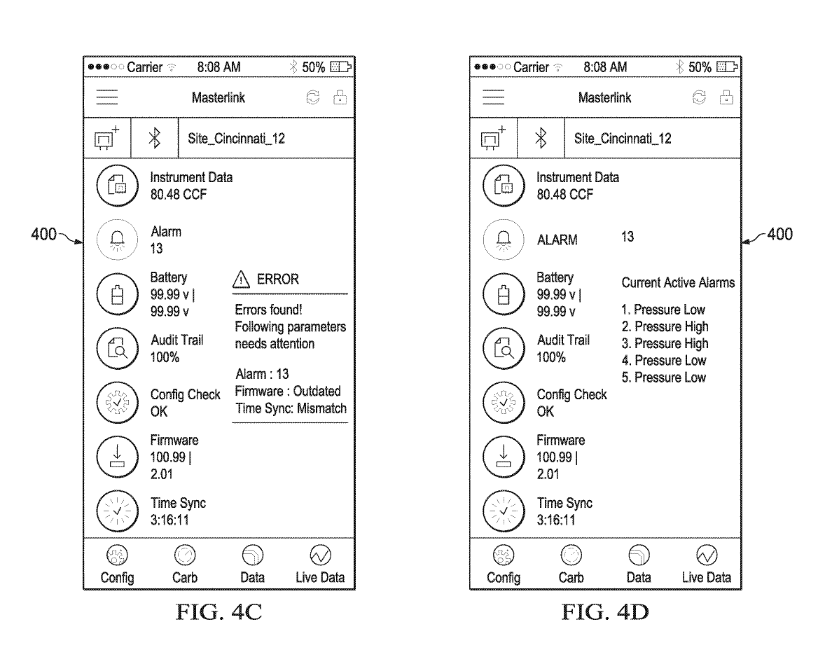

FIGS. 4A-4D illustrate a dashboard 400 with types of information according to this disclosure. The dashboard 400 is utilized by a mobile device, such as the mobile device 160, 204, and/or 300. The dashboard 400 is shown for illustration only, and different configurations for the dashboard 400 may be used in different embodiments.

In particular, FIGS. 4A-4D illustrate various example screenshots of possible implementations of the mobile app on the mobile device 204. These screenshots include screenshots of dashboards that can be displayed on the mobile device 204 to present the results of the maintenance tasks to a user. The details provided in FIGS. 4A-4D relate to specific implementations of the techniques, and other embodiments could be implemented in any other suitable manner in accordance with the teachings of this disclosure.

In FIG. 4A, the dashboard 400 illustrates an offline mode. The offline mode displays the different types of information, including instrument data, alarm, battery, audit trail, configuration “config” check, firmware, and time synchronization “sync”. As the dashboard 400 is in offline mode, none of the types of information show any data. Prior to the offline mode, the dashboard 400 may ask for a login or for a user to register a login.

FIG. 4B illustrates the dashboard 400 in a connected mode while connected to a particular field device, which in this example, is device Site_Cincinnati_12. Prior to connected mode, the dashboard 400 may display each of the possible devices that are connectable and allow the user to connect to some or all of the devices. During the connection, the dashboard 400 may show the progress of obtaining data for each of the types of information. The dashboard 400, in connected mode, shows the data for each type of information and can indicate whether there are any errors with any of the types of information.

FIG. 4C illustrates the dashboard 400 with multiple errors found. In this example, the alarm, firmware, and time sync each have at least one error. There are thirteen alarms, the firmware is outdated, and the time sync is mismatched.

FIG. 4D illustrates a dashboard 400 with one of the types of information selected. In this example, ‘alarm’ is selected, which is currently showing an error (as indicated in FIG. 4C). When a type of information is under error, the icon may be displayed in a different color, such as red. With ‘alarm’ selected, further detail about the type of information is shown. In this example, five types of active alarms are displayed.

Other types of information may show different details. For example, ‘instrument data’ can show, but is not limited to, corrected centum cubic-feet (CCF) volume, uncorrected CCF volume, P1 pressure, flow rate, dial rate, gas temp, and cellular diagnostics. ‘Battery’ can show a current voltage, last low voltage alarm, and radio battery voltage. ‘Audit trail’ can show a percentage and a number of items that are downloaded out of a total to be downloaded. ‘Config check’ shows whether the configuration item values are within range. ‘Firmware’ shows a current firmware versions, whether the firmware is updated, and if not, which version is recommended. ‘Time sync’ shows current time of device and actual time.

Although FIGS. 4A-4D illustrate one example of a dashboard 400 supporting automation of personalized maintenance tasks with built-in simulation and data synchronization support, various changes may be made to FIGS. 4A-4D. For example, various icons in FIGS. 4A-4D could be combined, further subdivided, or omitted and additional components could be added according to particular needs. The different icons could be rearranged within dashboard 400.

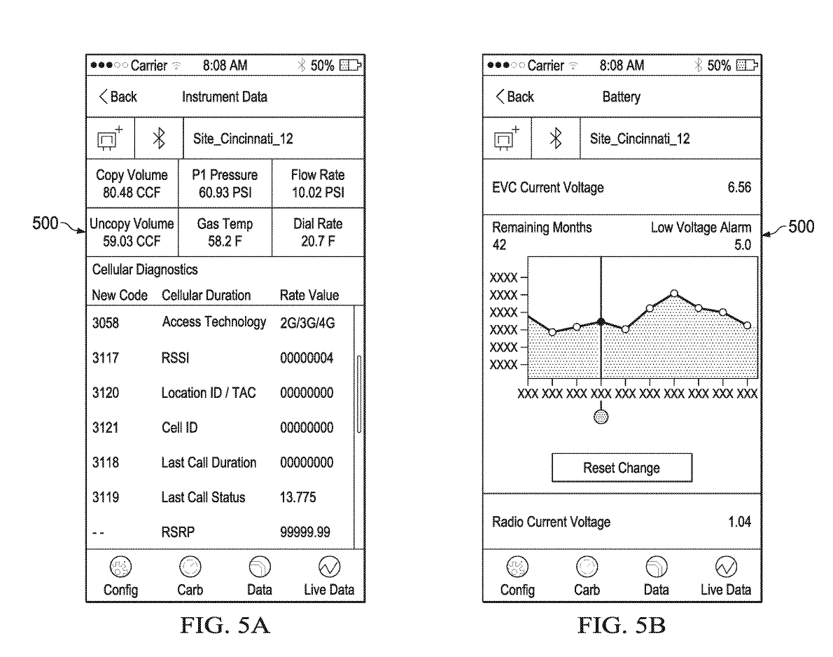

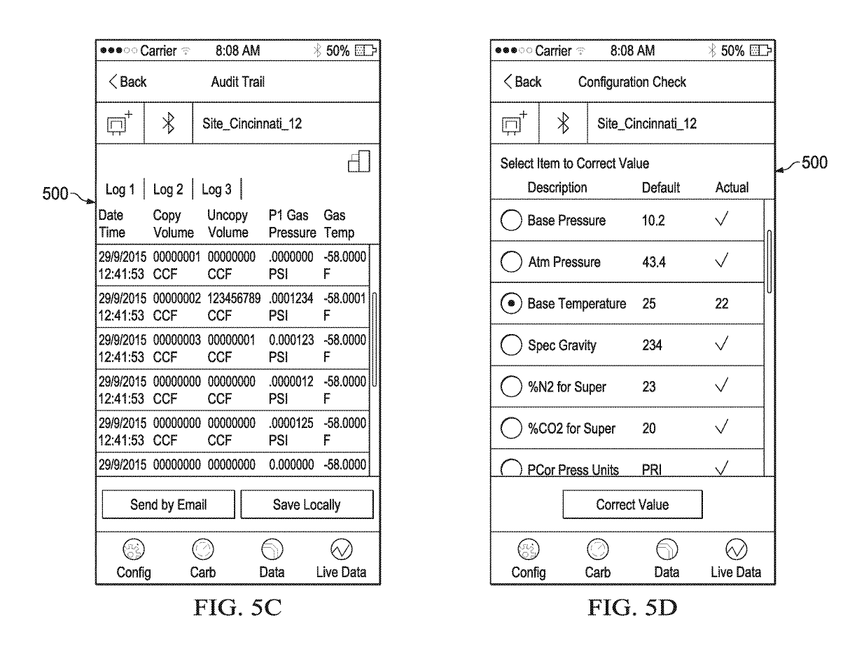

FIGS. 5A-5D illustrate a dashboard 500 with additional data according to this disclosure. The dashboard 500 is utilized by a mobile device, such as the mobile device 160, 204, and/or 300. The dashboard 500 is shown for illustration only, and different configurations for dashboard 500 may be used in different embodiments. The dashboard 500 shows further information about the types of information shown in the dashboard 400 of FIGS. 4A-4D. During use of the dashboard 400 of FIGS. 4A-4D, further data may be obtained by drilling down or selecting to calibrate, get further data, or live data. As noted above, the dashboard 400 can support drill-down for detailed information, meaning some results can be presented to a user and (in response to a user selection) more detailed results for the selected item can be presented to the user.

In FIG. 5A, the dashboard 500 shows additional data for the instrument data type of information. This data could include cellular diagnostics. Additional alarm information could allow a user to clear the different alarms and view more information related to each alarm. FIG. 5B illustrates the dashboard 500 with a history of voltage and current voltage, which can be reset. FIG. 5C illustrates the dashboard 500 with the logs of the audit trial. FIG. 5D illustrates a dashboard 500 with further configuration check details. This configuration check can allow a user to correct values of different measurements. The dashboard 500 can allow for firmware updates to select firmware versions and time sync corrections.

Although FIGS. 5A-5D illustrate one example of a dashboard 500 supporting automation of personalized maintenance tasks with built-in simulation and data synchronization support, various changes may be made to FIGS. 5A-5D. For example, various icons in FIGS. 5A-5D could be combined, further subdivided, or omitted and additional components could be added according to particular needs. The different icons could be rearranged within the dashboard 500.

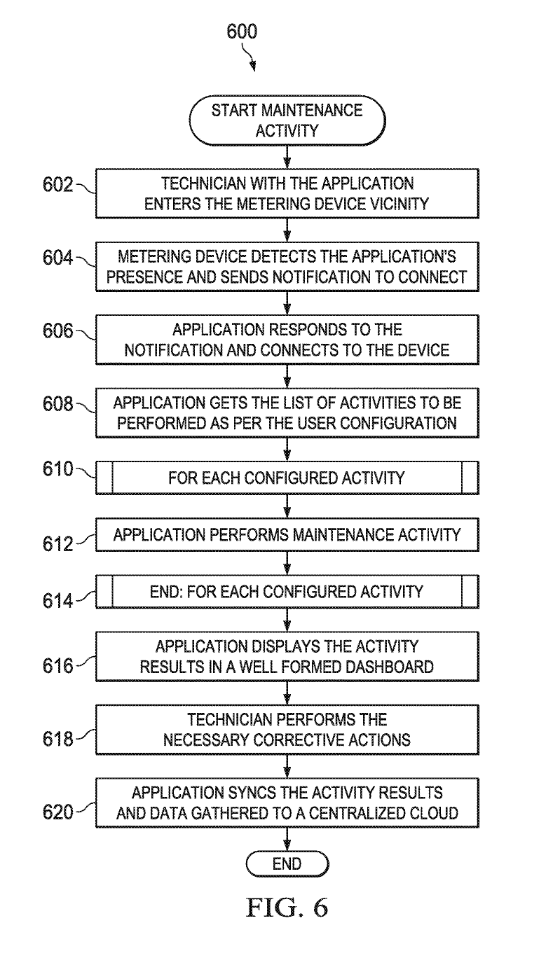

FIG. 6 illustrates an example method 600 supporting automation of personalized maintenance tasks according to this disclosure. The method 600 shown in FIG. 6 is for illustration only. The techniques and devices described in this disclosure could find use in a wide variety of situations and are not limited to the specific uses shown in FIG. 6. In one embodiment, the operations of the method 600 can be performed using mobile device 204 as shown in FIG. 2.

In one embodiment, at operation 602, a technician with an application enters a metering device's vicinity. The application could be executed on mobile device 204 and display dashboard 400 as shown in FIGS. 2 and 4. The metering device could be one example of a field device 202 as shown in FIG. 2.

At operation 604, the metering device detects the application's presence (or the mobile device's presence) and sends a notification to the mobile device to connect. At operation 606, the application responds to the notification and connects to the device. The application may receive a user input on the mobile device to accept the connection, or the connection may be automatic.

At operation 608, the application obtains a list of activities to be performed. The list of activities could be based on a user configuration. The list of activities could include updating the different types of information as selected in the dashboard 400 or 500. At operations 610-614, for each configured activity, the application performs a maintenance activity. The method 600 executes operations 610-614 for each activity (or selected type of information).

At operation 616, the application displays the activity results in a dashboard. At operation 618, the technician performs corrective actions using the dashboard. These displayed activity results (or types of information and data) can be corrected or adjusted using the dashboards 400 and 500.

At operation 620, the application synchronizes the activity results and data gathered to a centralized cloud. The data can be sent to a remote device.

Although FIG. 6 illustrates one example of a method 600 for supporting automation of personalized maintenance tasks, various changes may be made to FIG. 6. For example, while FIG. 6 shows a series of steps, various steps could overlap, occur in parallel, occur in a different order, or occur any number of times.

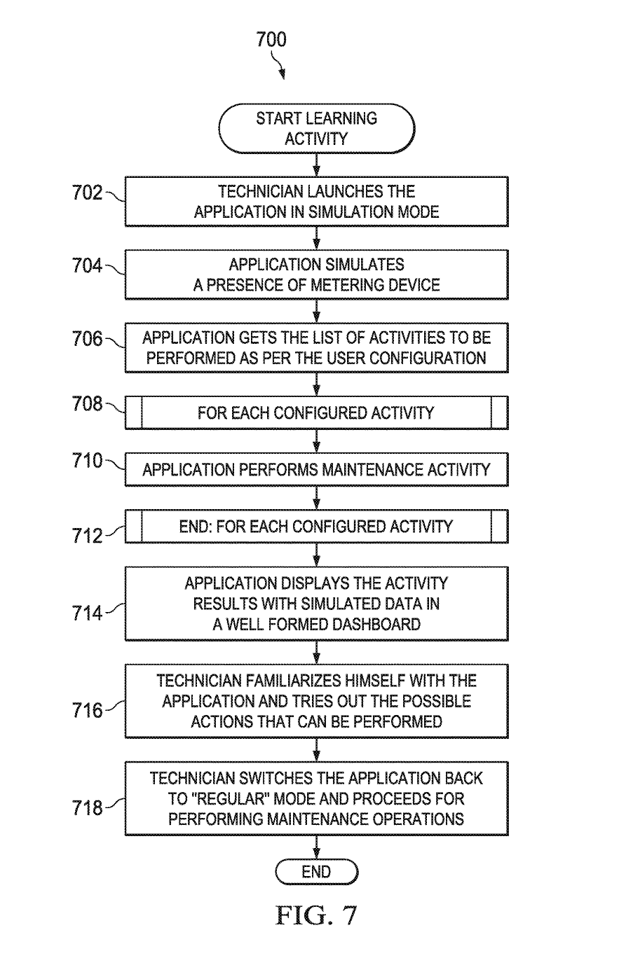

FIG. 7 illustrates an example method 700 supporting simulation of personalized maintenance tasks according to this disclosure. Method 700 shown in FIG. 7 is for illustration only. The techniques and devices described in this disclosure could find use in a wide variety of situations and are not limited to the specific uses shown in FIG. 7. In one embodiment, the operations of method 700 can be performed using mobile device 204 as shown in FIG. 2.

In one embodiment, at operation 702, a technician launches an application in simulation mode. The application could be executed on mobile device 204 and display dashboard 400 as shown in FIGS. 2 and 4. At operation 704, the application simulates a presence of a metering device. The metering device could be one example of a field device 202 as shown in FIG. 2.

At operation 706, the application obtains a list of activities to be performed. The list of activities could be based on a user configuration. The list of activities could include updating the different types of information as selected in the dashboard 400 or 500. At operations 708-712, for each configured activity, the application performs a maintenance activity. The method 700 executes operations 708-712 for each activity (or selected type of information).

At operation 714, the application displays the activity results with simulated data in a dashboard. At operation 716, the technician can perform different actions in the application based on the simulated activity results.

At operation 718, the technician switches the application to regular mode and proceeds to perform maintenance operations. The technician can begin to use the mobile device for method 600 as shown in FIG. 6.

Although FIG. 7 illustrates one example of a method 700 for supporting simulation of personalized maintenance tasks, various changes may be made to FIG. 7. For example, while FIG. 7 shows a series of steps, various steps could overlap, occur in parallel, occur in a different order, or occur any number of times.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. §112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. §112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
detecting a field device in proximity to a mobile device;
executing multiple maintenance tasks associated with the field device in response to detecting the field device; and
generating a dashboard and presenting the dashboard on the mobile device, the dashboard displaying results of the maintenance tasks to a user.

2. The method of claim 1, wherein detecting the field device comprises at least one of:
detecting a beacon associated with the field device; and
detecting a pairing of the mobile device with the field device.

3. The method of claim 1, wherein executing the maintenance tasks comprises communicating with the field device through a low-power communication interface.

4. The method of claim 1, wherein the dashboard supports drill-down from more general results of the maintenance tasks to more specific results of the maintenance tasks.

5. The method of claim 1, further comprising:
preventing re-execution of the maintenance tasks.

6. The method of claim 1, further comprising:
automatically sending the results of the maintenance tasks to a remote device or system for storage.

7. The method of claim 1, further comprising:
providing a simulation of the field device such that the user is able to initiate simulated execution of the maintenance tasks when not in proximity to the field device.

8. A mobile device comprising:
a transceiver configured to communicate with a field device; and
at least one processing device configured to:
detect a presence of the field device;
execute multiple maintenance tasks associated with the field device in response to detecting the presence of the field device; and
generate a dashboard and present the dashboard on the mobile device, the dashboard displaying results of the maintenance tasks to a user.

9. The mobile device of claim 8, wherein the at least one processing device is further configured to:
detect a beacon associated with the field device; and
detect a pairing of the mobile device with the field device.

10. The mobile device of claim 8, wherein the at least one processing device is further configured to communicate with the field device through a low-power communication interface.

11. The mobile device of claim 8, wherein the dashboard supports drill-down from more general results of the maintenance tasks to more specific results of the maintenance tasks.

12. The mobile device of claim 8, wherein the at least one processing device is further configured to prevent re-execution of the maintenance tasks.

13. The mobile device of claim 8, wherein the at least one processing device is further configured to automatically send the results of the maintenance tasks to a remote device or system for storage.

14. The mobile device of claim 8, wherein the at least one processing device is further configured to provide a simulation of the field device so that the user is able to initiate simulated execution of the maintenance tasks when not in proximity to the field device.

15. A non-transitory computer readable medium containing instructions that, when executed by at least one processing device, cause the at least one processing device to:
detect a field device in proximity to a mobile device;
execute multiple maintenance tasks associated with the field device in response to detecting the field device; and
generate a dashboard and present the dashboard on the mobile device, the dashboard displaying results of the maintenance tasks to a user.

16. The non-transitory computer readable medium of claim 15, wherein the instructions, when executed, further cause the at least one processing device to:
detect a beacon associated with the field device; and
detect a pairing of the mobile device with the field device.

17. The non-transitory computer readable medium of claim 15, wherein the instructions, when executed, further cause the at least one processing device to communicate with the field device through a low-power communication interface.

18. The non-transitory computer readable medium of claim 15, wherein the dashboard supports drill-down from more general results of the maintenance tasks to more specific results of the maintenance tasks.

19. The non-transitory computer readable medium of claim 15, wherein the instructions, when executed, further cause the at least one processing device to prevent re-execution of the maintenance tasks.

20. The non-transitory computer readable medium of claim 15, wherein the instructions, when executed, further cause the at least one processing device to automatically send the results of the maintenance tasks to a remote device or system for storage.
